(19) United States
(12) Patent Application Publication
(10) Pub. No.: US 2026/0044430 A1
(43) Pub. Date: Feb. 12, 2026

(54) SELF-HEALING STATIC CODE CHECKS

(71) Applicant: SAP SE, Walldorf (DE)

(72) Inventors: Ralf Schroth, Bad Schoenborn (DE); Andreas Schoknecht, Linkenheim-Hochstetten (DE); Abhishek Roy, Bangalore (IN)

(21) Appl. No.: 18/798,313

(22) Filed: Aug. 8, 2024

(51) Int. Cl. G06F 11/36

(52) U.S. Cl. CPC G06F 11/3608

(57) ABSTRACT

Systems and methods described herein relate to self-healing static code checks. Job structure metadata for an automated static code check defines a plurality of jobs. The jobs are scheduled such that execution of at least a first subset of the jobs is dependent on successful completion of at least a second subset of the jobs. While the automated static code check is in progress, a plurality of snapshots of the automated static code check is automatically generated for respective points in time. An event is detected based on the job structure metadata and a particular snapshot. The event includes a job failure or the automated static code check exceeding a predetermined runtime threshold. A corrective action is triggered, which may include automatically terminating and triggering re-execution of one or more of the jobs of the automated static code check.

### TECHNICAL FIELD

The subject matter disclosed herein generally relates to technology for analyzing development artifacts in the context of software development. More specifically, but not exclusively, the subject matter relates to systems and methods for performing automated and self-healing static code checks.

### BACKGROUND

In a typical software development pipeline, development is initially performed in a development environment, and certain checks and tests are performed (or even explicitly required) before software is deployed to a production environment. These checks often include static code checks.

Static code checking, also referred to as static code analysis, includes the examination of code for issues or vulnerabilities without executing the code. Automated tools for static code checks can automatically check for issues or vulnerabilities, such as programming errors, coding standard violations, undefined values, syntax violations, or security vulnerabilities in a variety of development artifacts, potentially identifying problems that may be overlooked during manual reviews. Failure or stalling of an automated static code check can, at least in some cases, significantly delay the integration of modifications (e.g., new or amended code) into a production environment.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment that includes a static code checking system, according to some examples.

FIG. 2 is a block diagram of components of a static code checking system, according to some examples.

FIG. 3 is a diagrammatic illustration of certain interactions between components of a static code checking system, according to some examples.

FIG. 4 is a flowchart illustrating operations of a method for performing an automated and self-healing static code check.

FIG. 5 is a swim-lane flowchart illustrating operations performed by a pipeline dispatching component, a job scheduling component, a job execution component, and a watchdog component, respectively, to provide a method for performing an automated and self-healing static code check, according to some examples.

FIG. 6 is a block diagram showing a software architecture for a computing device, according to some examples.

FIG. 7 is a block diagram of a machine in the form of a computer system, according to some examples, within which instructions may be executed for causing the machine to perform any one or more of the methodologies discussed herein.

### DETAILED DESCRIPTION

An automated static code check can include multiple distinct jobs. For example, the automated static code check includes a set of preparatory jobs (e.g., 5-10 preparatory jobs) that are performed prior to a set of code checking jobs (e.g., 10-15 code checking jobs). Preparatory jobs can include, for example, prerequisite checks that ensure the environment is ready for code analysis, environmental setup operations, metadata retrieval, checking of naming conventions, dependency resolution, or configuration validation. Code checking jobs can include, for example, unreachable code detection, dictionary checks, unused variable detection, resource leak detection, null pointer dereferencing, development guideline compliance checks, or hardcoded credential checks.

Some jobs may be dependent on others. For example, a static code checking system has to complete the preparatory jobs before the code checking jobs can start, or a first one of the jobs has to be completed before the static code checking system can start executing a second one of the jobs. Some automated static code checks thus involve a series of jobs to be performed in a specific order.

Various technical problems, such as intermittent database performance issues, can cause jobs within an automated static code check to fail or be delayed. The failure or stalling of a single job can delay or even invalidate an entire automated static code check, particularly when there are dependencies between the jobs. As mentioned, a static code check may be mandatory in some software development pipelines, which means that these technical problems can disrupt the planned integration of modifications into a production environment. Human intervention does not adequately address these issues, as such intervention can result in further delays, inefficient resource usage, or an increased risk of errors.

Examples described herein enable automated and self-healing static code checks. In some examples, a self-healing mechanism is incorporated into a static check pipeline. An inventory of jobs and their dependencies can be defined using job structure metadata, with a watchdog process automatically monitoring the job chain. If a job in the job chain fails or stalls, the watchdog process may automatically terminate running jobs. In some examples, such as where a particular failure would invalidate an overall result, the watchdog process automatically cancels the entire job chain.

Furthermore, the watchdog process may monitor the overall execution time of the job chain and take corrective action if the overall execution time exceeds a runtime threshold. In some examples, a state of the job chain is reset and re-execution thereof is triggered. Alert notifications may be transmitted to user devices to indicate encountered errors or self-healing actions that were automatically triggered.

An example method includes accessing job structure metadata for an automated static code check to be performed for a batch of development artifacts prior to integration into a production environment. The job structure metadata defines a plurality of jobs of the automated static code check. The jobs are scheduled according to the job structure metadata such that execution of at least a first subset of the plurality of jobs is dependent on successful completion of at least a second subset of the plurality of jobs.

Job structure metadata may include information that defines the characteristics or relationships of various jobs within a static code checking system. The job structure metadata may contain details such as the sequence in which jobs should be executed (e.g., job chain), dependencies between different jobs, and conditions under which specific jobs should be triggered. The job structure metadata can be dynamically updated to reflect changes in job configurations or to introduce new jobs into the static code checking system.

In some examples, the job structure metadata includes runtime information or expected runtime information, such as a predetermined runtime threshold. The predetermined runtime threshold may be an overall runtime threshold for the automated static code check, with the job structure metadata also, in some examples, defining an individual runtime threshold for one or more of the jobs.

The method may include commencing execution of the automated static code check and, while the automated static code check is in progress, automatically and periodically executing the watchdog process to generate a plurality of snapshots of the automated static code check. In some examples, each snapshot indicates which of the plurality of jobs have been triggered and are still running at a respective point in time.

In some examples, the static code checking system detects, based on the job structure metadata and a particular snapshot, an event. The event may be a job failure within the automated static code check. Alternatively, or additionally, the event may be that the automated static code check exceeded a predetermined runtime threshold.

In response to detecting the event, the static code checking system automatically terminates one or more of the jobs of the automated static code check, and triggers re-execution of the one or more terminated jobs. In some examples, the static code checking system uses the job structure metadata to identify which jobs are expected to be running and what their dependencies are. In this way, the static code checking system can detect a job failure by comparing a current state of the automated static code check with an expected state thereof.

A “snapshot,” as used herein, may include a recorded state of the automated static code check at a specific point in time. For example, a snapshot captures the status and details of ongoing jobs within the system, such as which jobs are active, which have completed, or any errors or issues that have occurred up to that moment. By processing the snapshot, the watchdog process is enabled to automatically intervene by terminating and restarting one or more jobs, thereby performing self-healing operations.

In some examples, the job failure comprises stalling of a particular job of the plurality of jobs. The job failure may be detected based on the individual runtime threshold being exceeded for the particular job.

The method may further include detecting that the automated static code check was successfully completed, and, in response to detecting that the automated static code check was successfully completed, automatically transmitting a completion message to at least one user device associated with the batch of development artifacts. The completion message may indicate that the automated static code check was successfully run. The completion message may also include results of the automated static code check (e.g., an indication of any issues flagged or returned). Alternatively or additionally, the method may include, in response to detecting the event, automatically transmitting a failure message to a user device associated with an administrator. The failure message may indicate that the automated static code check was not successfully run.

As mentioned, the static code checking job can be run with respect to a batch of development artifacts. In some examples, the batch comprises a plurality of development artifacts within a checking pipeline, with the static code checking system aggregating the batch into the checking pipeline based on a predetermined set of rules to cause the batch of development artifacts to undergo the automated static code check.

A “batch of development artifacts,” as used herein, may include a collection of one or more of code, configurations, and associated data that are grouped together for processing or analysis in a static code checking system. For example, the artifacts can include not only code artifacts, but also other artifacts such as database artifacts or database contents. Unlike continuous integration/continuous deployment (CI/CD) systems where checks are triggered by individual changes or change lists, examples described herein are applied to a batch of development artifacts that represents a consolidated set of modifications, changes, or updates that are analyzed collectively. Accordingly, in the context of the present disclosure, for each artifact in a “batch of development artifacts,” the artifact is the whole artifact (e.g., the entire object). In other words, the whole artifact is taken and assessed as part of a static check, rather than applying a delta/difference and assessing only such delta/difference as is the case in various other configuration management tools. In some implementations, a batch includes a collected set of “transports” within a software development pipeline, upon which static code analysis is to be performed.

Examples described herein address technical challenges associated with handling job failures or delays within static code checking processes. An automated monitoring process may periodically generate snapshots of a static code check, providing a view of the status of its jobs. In some examples, when an adverse event is detected, the static code checking system automatically terminates the problematic job, or the entire static code check, and triggers its re-execution. In this way, the static code checking system is provided with self-healing capabilities that can make static code checks faster and more efficient, while also reacting more rapidly to certain errors or other events.

In some examples, the static code checking system as described herein allows for code checks to be performed at higher execution frequencies, even in the presence of technical issues such as intermittent interrupts, failures, or performance degradations, without the need for manual interventions. The watchdog process, for instance, ensures that failures or performance issues within the pipeline are detected and addressed promptly, minimizing downtime and accelerating the recovery process.

A static code checking system as described herein may also provide more detailed insights into the status of individual jobs by utilizing the watchdog process and its periodic generation of snapshots. Such snapshots allow for real-time monitoring of each job status, including which jobs have been triggered, are still in progress, or have completed. This enhanced visibility enables quicker identification and resolution of issues such as unmet job dependencies or unexpected delays in job execution.

By enabling a computing system to complete static code checks more quickly and efficiently, the operation of the computing system is improved. Moreover, the computing system can save computing resources in the process, such as processor cycles, network traffic, memory usage, graphics processing unit (GPU) resources, data storage capacity, power consumption, and cooling capacity.

Examples in the present disclosure relate to specific practical applications, such as the practical application of performing an automated static code check in a more efficient or effective manner on a computing system. It is further noted that the improvements in speed, efficiency, or resource management, or the reduction in downtime as described herein, cannot be accomplished without computer technology due to the specific processes that are required to be executed in the techniques described herein.

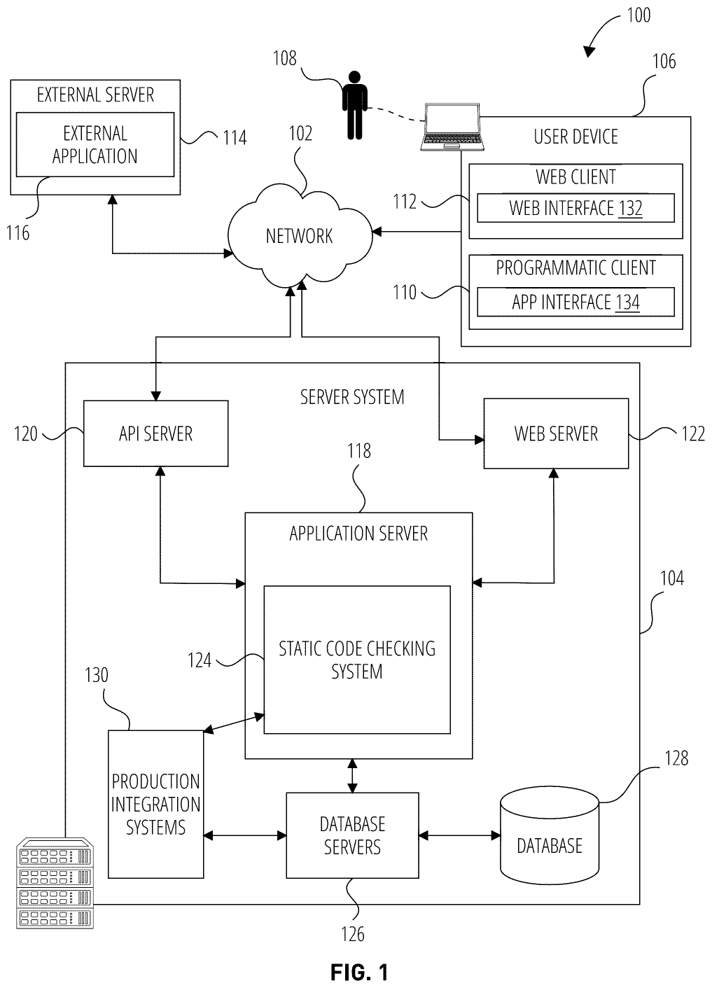

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 108. A web client 112 (e.g., a browser) or a programmatic client 110 (e.g., an “app”) may be hosted and executed on the user device 106.

An Application Program Interface (API) server 120 and a web server 122 provide respective programmatic and web interfaces to components of the server system 104. An application server 118 hosts a static code checking system 124, which includes components, modules, or applications.

The user device 106 can communicate with the application server 118, for example, via the web interface supported by the web server 122 or via the programmatic interface provided by the API server 120. It will be appreciated that, although only a single user device 106 is shown in FIG. 1, a plurality of user devices may be communicatively coupled to the server system 104 in some examples. Further, while certain functions may be described herein as being performed at either the user device 106 (e.g., web client 112 or programmatic client 110) or the server system 104, the location of certain functionality either within the user device 106 or the server system 104 may be a design choice.

The application server 118 is communicatively coupled to database servers 126, facilitating access to one or more information storage repositories, such as a database 128. In some examples, the database 128 includes storage devices that store information to be processed by the static code checking system 124, such as development artifacts to be checked or job structure metadata used by the static code checking system 124 to execute static code checks.

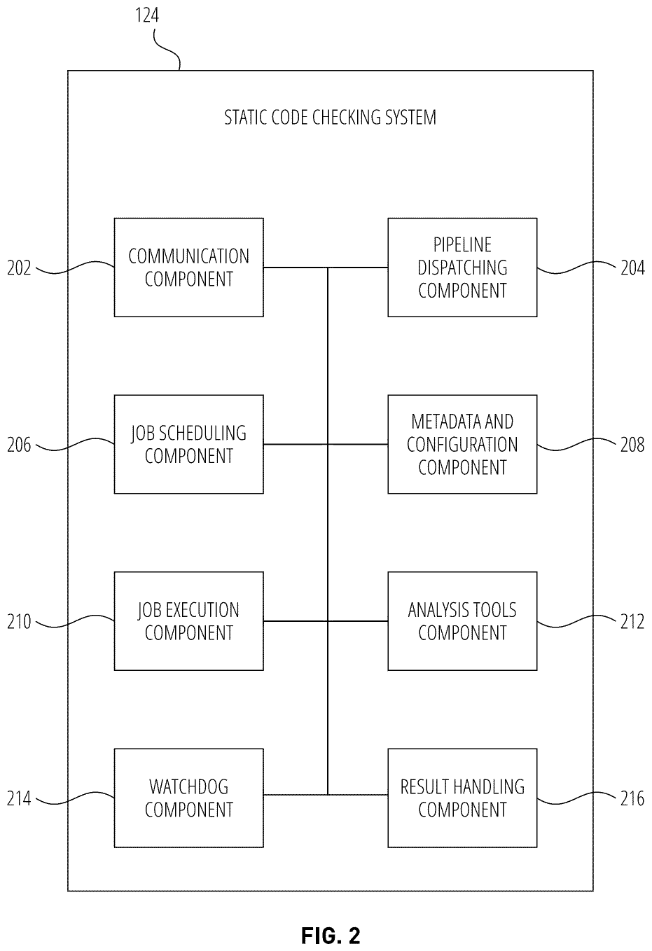

The application server 118 accesses application data (e.g., application data stored by the database servers 126) to provide one or more applications or software tools to the user device 106 via a web interface 132 or an app interface 134. As described further below according to examples, and with specific reference to FIGS. 2-5, the application server 118, using the static code checking system 124, may provide one or more tools or functions for performing automated and self-healing static code checks. The static code checking system 124 may also provide one or more tools or functions for configuring or managing static code checks, or receiving updates related to static code checks.

In some examples, the static code checking system 124 operates to perform automated static code checks to check batches of development artifacts before they are integrated into a main code base associated with a production environment. In some examples, the static code checking system 124 communicates with production integration systems 130 to transfer checked development artifacts to other systems, such as testing or quality assurance systems, or to the production environment itself.

The static code checking system 124 may leverage job structure metadata to define and schedule a plurality of jobs specified for comprehensive static code analysis. In some examples, the static code checking system 124 handles execution of these jobs and manages their progression through various stages of the checking process. The static code checking system 124 is configured to automatically and periodically execute a watchdog process that generates snapshots reflecting the current state of the jobs at specific points in time.

In some examples, the static code checking system 124 is further capable of detecting events, such as job failures or the exceeding of predetermined runtime thresholds, based on comparisons between the job structure metadata and the snapshots. Upon detecting such events, the static code checking system 124 can automatically terminate and trigger the re-execution of the affected jobs, ensuring the integrity or reliability of the code checking process. The static code checking system 124 may be configured to resolve or correct issues in real-time (or near-real-time) to maintain or improve the efficiency of its automated static code checks.

The static code checking system 124 may provide one or more user interfaces, such as a graphical user interface (GUI) that provides a dashboard at the user device 106 via the web interface 132. The user interface may be generated so as to summarize or provide information related to static code checks that have been performed, are in progress, or are yet to be performed. The user interface may also provide information related to particular jobs of a static code check or events detected by the static code checking system 124. The user 108 can provide inputs via the user interface, such as inputs that configure job structure metadata by adding jobs or changing details of jobs.

In some examples, the application server 118 is part of a cloud-based platform that allows the user 108 to utilize or benefit from the tools of the static code checking system 124. For example, the user 108 may be an account holder that can use their account to access the static code checking system 124 and, once accessed, create, manage, or track static code checks. In some examples, one or more cloud instances are associated with the account.

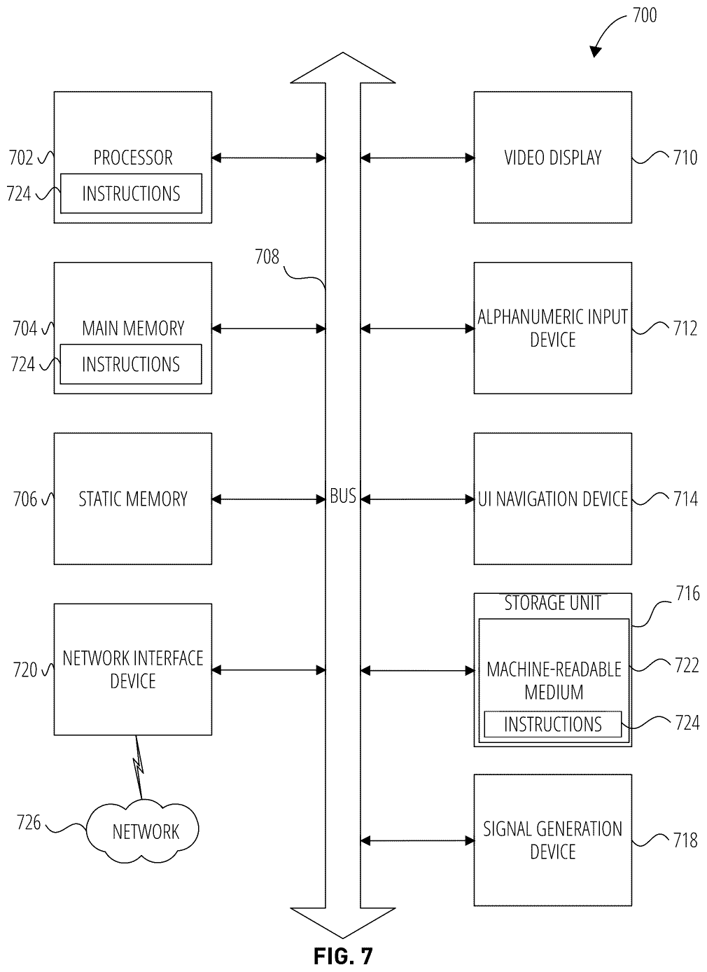

One or more of the application server 118, the database servers 126, the API server 120, the web server 122, and the static code checking system 124 may each be implemented in a computer system, in whole or in part, as described below with respect to FIG. 7. In some examples, external applications (which may be third-party applications or applications provided by the same entity that provides the static code checking system 124), such as an external application 116 executing on an external server 114, can communicate with the application server 118 via the programmatic interface provided by the API server 120. For example, a third-party application may support one or more features or functions on a website or platform hosted by a third party, or may perform certain methodologies and provide input or output information to the application server 118 for further processing or publication.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

FIG. 2 is a block diagram of components of a static code checking system, according to some examples. The static code checking system 124 is shown to include a communication component 202, a pipeline dispatching component 204, a job scheduling component 206, a metadata and configuration component 208, a job execution component 210, an analysis tools component 212, a watchdog component 214, and a result handling component 216.

The communication component 202 receives data sent to the static code checking system 124 and transmits data from the static code checking system 124. For example, the communication component 202 is responsible for handling the communication of static check-related data, such as static check instructions, status updates, error reports, reports of corrective actions, or completion notifications. In some examples, the communication component 202 facilitates the aggregation of results from static code checks, preparing them for further analysis. The communication component 202 may enable the static code checking system 124 to respond to detected events by ensuring that alerts or commands related to job terminations and restarts are promptly and accurately communicated.

In some examples, the communication component 202 manages the generation and dynamic adjustment of a user interface provided by the static code checking system 124 (e.g., the web interface 132). In this way, the user 108 can interact with the static code checking system 124 and receive information regarding automated static code checks.

The pipeline dispatching component 204 is responsible for determining the jobs to be performed within a static code check based on predefined job structure metadata. In some examples, the pipeline dispatching component 204 determines which jobs are relevant at any given time and triggers their execution accordingly. In some examples, the pipeline dispatching component 204 assesses dependencies and prerequisites among jobs to ensure that jobs are structured or triggered in the correct sequence (e.g., to avoid errors or anomalies, to manage a workflow, or to prevent conflicts).

The job scheduling component 206 is configured to schedule jobs and allocate resources for such jobs. Accordingly, the job scheduling component 206 is responsible for managing timing and resource allocation for each job to regulate system performance and job throughput. In some examples, the job scheduling component 206 uses algorithms to dynamically schedule jobs, based, for example, on job hierarchies, prerequisites or interdependencies between jobs, task priorities, system load, or resource availability. The job scheduling component 206 is configured to adhere to job structures as defined or managed by the pipeline dispatching component 204.

The metadata and configuration component 208 maintains metadata related to jobs, including, for example, their processes, configurations, execution parameters, dependencies, expected duration, or combinations thereof. As mentioned, such data may be referred to as job structure metadata. The metadata and configuration component 208 may also store and manage check profiles, such as a list of jobs associated with each particular type of static code check supported by the static code checking system 124.

For example, the user 108 may select a particular type of static code check via the web interface 132, allowing the static code checking system 124 to identify the job structure metadata associated with that static code check and load the relevant jobs accordingly. The user 108 may also, in some examples, be enabled to modify the jobs associated with a particular automated static code check via the metadata and configuration component 208. In some examples, the metadata and configuration component 208 also handles automatic updates and modifications to job configurations, ensuring that the static code checking system 124 adapts to changes in project requirements or operational conditions.

The pipeline dispatching component 204, the job scheduling component 206, or other components of the static code checking system 124 can communicate with the metadata and configuration component 208 to obtain relevant job structure metadata. For example, the pipeline dispatching component 204 can access, via the metadata and configuration component 208, the relevant job structure for a new automated static code check, and the job scheduling component 206 can use that job structure (e.g., constraints or dependencies) to schedule the jobs.

The job execution component 210 is responsible for executing the jobs dispatched by the pipeline dispatching component 204 and scheduled by the job scheduling component 206. In other words, the job execution component 210 manages the actual running of the jobs, overseeing their execution according to the specifications provided by the metadata and configuration component 208 or according to other predefined specifications. In some examples, the job execution component 210 monitors the execution status of each job, handles errors, and ensures that job outputs are correctly generated and stored.

The job execution component 210 can work with the analysis tools component 212. The analysis tools component 212 provides the static code checking system 124 with access to various pre-built tools for analyzing development artifacts. For example, the analysis tools component 212 can include predefined modules for running unreachable code detection, dictionary checks, unused variable detection, resource leak detection, null pointer dereferencing, or hardcoded credential checks. These tools can be used to run respective jobs or parts thereof. The analysis tools component 212 can be updated or modified over time to include new or modified analysis tools. In this way, the job execution component 210 can perform all necessary checks on the relevant batch of development artifacts.

The watchdog component 214 automatically monitors the health and performance of an automated static code check. In some examples, the watchdog component 214 periodically checks the status of ongoing jobs and detects issues such as job failures (e.g., stalls or outright failures) or excessive runtime. Upon detecting such events, the watchdog component 214 initiates predefined corrective actions, which may include terminating stalled jobs and triggering their re-execution. In some examples, the corrective action includes a full restart and re-execution of an automated static code check in its entirety. In other examples, the corrective action includes a partial restart and re-execution (e.g., only restarting jobs that still need to be successfully completed in order for the automated static code check to be designated as completed).

The watchdog component 214 ensures that the static code checking system 124 operates within its expected parameters and can self-correct in the face of operational disruptions, thereby maintaining the reliability and efficiency of a static code checking process. In some examples, the watchdog component 214 is periodically executed according to a predetermined interval. For example, the interval might be every one minute, every five minutes, every ten minutes, or every twenty minutes.

The result handling component 216 is responsible for managing outcomes of static code checks performed by the static code checking system 124. For example, a static code check may be passed (e.g., indicating no issues or vulnerabilities are to be reported) or failed (e.g., indicating that one or more issues or vulnerabilities are to be reported). The result handling component 216 may process and store results to ensure they are accessible for further analysis or reporting.

The result handling component 216 may, for example, report via the communication component 202 on whether the development artifacts checked by a particular automated static code check (or part thereof) have passed or failed. Further detail may also be included, such as which issues or vulnerabilities were revealed, to allow the user 108 to address them. In some examples, the result handling component 216 interfaces with other systems or databases, such as the production integration systems 130, to export results for integration into other parts of the software development lifecycle (e.g., code repositories or issue tracking systems).

In some examples, at least some of the components shown in FIG. 2 are configured to communicate with each other to implement aspects described herein. One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

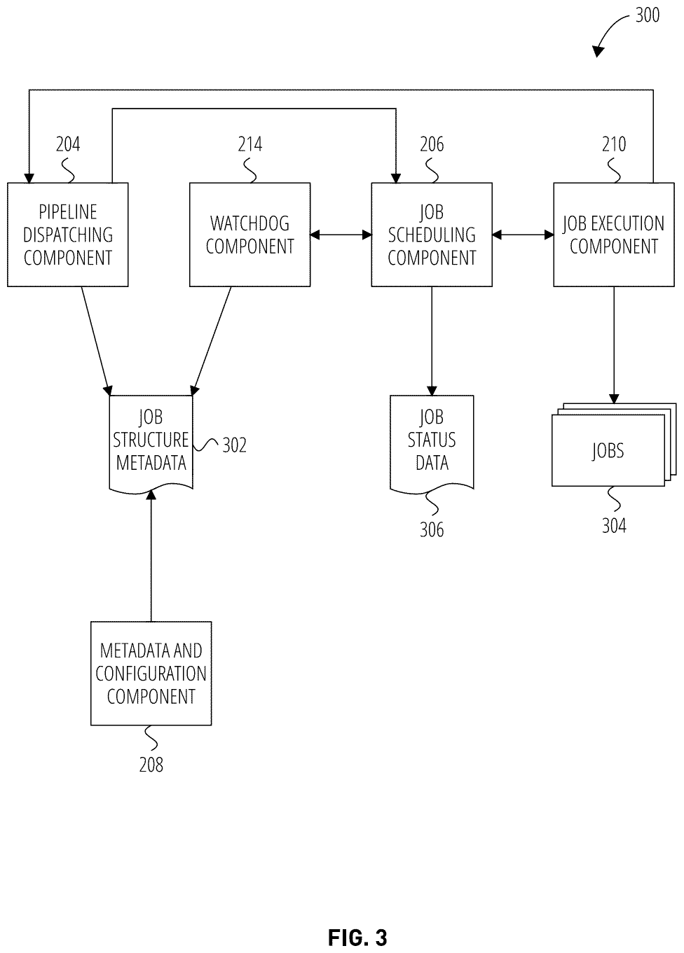

FIG. 3 shows a diagram 300 that illustrates interactions between certain components of the static code checking system 124, according to some examples. Specifically, the diagram 300 includes the pipeline dispatching component 204, the watchdog component 214, the job scheduling component 206, the job execution component 210, and the metadata and configuration component 208 of FIG. 3.

As shown in FIG. 3, the pipeline dispatching component 204 and the watchdog component 214 both access job structure metadata 302 provided or maintained by the metadata and configuration component 208. The job structure metadata 302 can include at least the details of the various jobs associated with a particular automated static code check as well as the details of dependencies between those jobs. In some examples, the job structure metadata 302 for a particular static check includes at least the following metadata to enable the static code checking system 124 to construct a job chain with the correct set of jobs in the correct order/structure for a particular run:
A list of relevant job identifiers (e.g., the names or identifying codes of the relevant jobs)
Dependency information, such as, for each job, whether the job is to start executing when the static code check commences, or is to be triggered by the completion of a predecessor job.
Classification information that identifies custom or special jobs, such as a particular job that is to be run only once per day or once per week (e.g., not within each static code check).

The pipeline dispatching component 204 communicates with the job scheduling component 206 to schedule jobs 304 within an automated static code check to be performed for a particular batch of development artifacts, and the job execution component 210 executes the jobs 304. The watchdog component 214 uses the job structure metadata 302 and snapshots obtained while the automated static code check is running to check for specific events.

For example, the pipeline dispatching component 204 uses job status data 306 generated by the job scheduling component 206 and a job inventory or chain generated from the job structure metadata to compare an expected state of the automated static code check with the actual state of the automated static code check (e.g., as indicated by the job status data 306 at a particular point in time). In response to detecting a specific event, the watchdog component 214 can automatically trigger a corrective action, as described elsewhere in the present disclosure. The watchdog component 214 may then communicate with the job scheduling component 206, for example, to cause re-execution of one or more of the jobs 304.

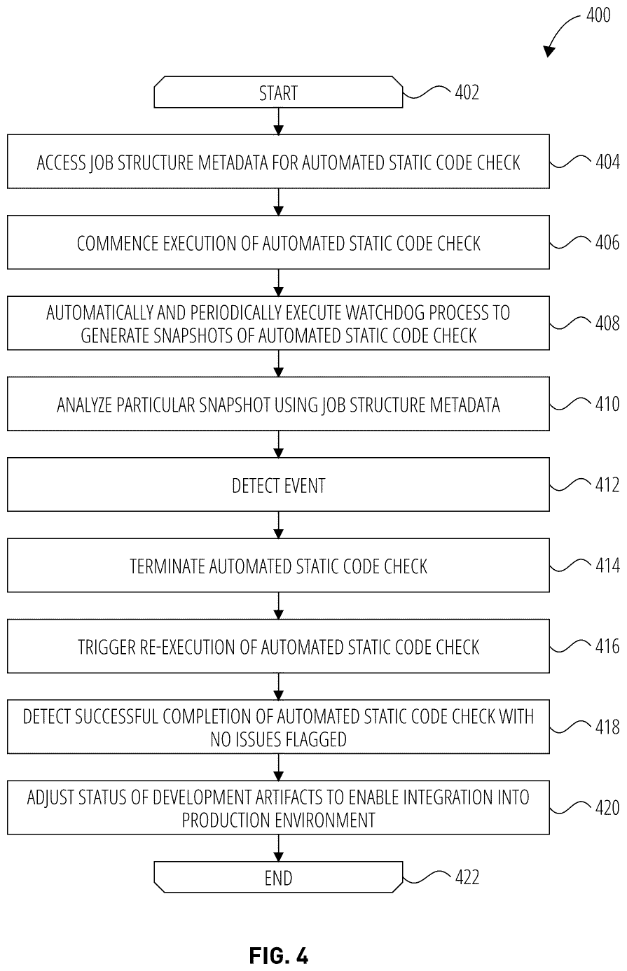

FIG. 4 is a flowchart illustrating operations of a method 400 for performing an automated and self-healing static code check. By way of example and not limitation, aspects of the method 400 may be performed by components, devices, or systems shown in FIG. 1 and FIG. 2, and some of them are thus referenced below.

The method 400 commences at opening loop operation 402 and proceeds to operation 404, where the static code checking system 124 accesses job structure metadata for an automated static code check. For example, before new or modified code can be merged into a main repository, the static code checking system 124 is used to perform the automated static code check to check for issues or vulnerabilities. The job structure metadata indicates the relevant jobs to be performed and the manner in which the jobs should be structured (e.g., an order of the jobs or dependencies between the jobs).

At operation 406, the static code checking system 124 commences execution of the automated static code check. For example, the static code checking system 124 starts with a first job, or a first set of jobs. While the automated static code check is in progress, the watchdog component 214 of the static code checking system 124 periodically executes a watchdog process to generate snapshots of the automated static code check, as indicated by operation 408. It is noted that while this is represented by a single operation in FIG. 4, the watchdog process can be periodically performed and thus a new watchdog operation can occur, for example, every 3, 5, or 10 minutes. In some examples, this interval is adjustable or configurable.

The method 400 proceeds to operation 410, where the static code checking system 124 analyzes a particular snapshot using the job structure metadata. For example, based on information in the job structure metadata, such as a defined job chain and expected job durations (e.g., based on historic data related to the relevant jobs), the static code checking system 124 constructs an expected state of the automated static code check for the relevant point in time (e.g., the time point associated with the particular snapshot). This allows the static code checking system 124 to automatically compare a current state of the automated static code check with an expected state thereof.

At operation 412, the watchdog component 214 detects an event. For example, the watchdog component 214 detects that a particular job has stalled based on the comparison with the expected state, or detects that the static code check as a whole has exceeded a runtime threshold (e.g., as defined within the job structure metadata based on historical data or process requirements).

In response to detecting the event, the static code checking system 124 terminates the automated static code check (operation 414) and triggers re-execution of the automated static code check (operation 416). In some examples, the static code checking system 124 detects multiple events at different points in time and causes the automated static code check to be re-executed a number of times before it is eventually successfully completed. For example, the database 128 may be experiencing intermittent connectivity or performance issues, causing the automated static code check to fail a number of times. The static code checking system 124 automatically self-heals the automated static code check and it can then be successfully completed once the database issues are no longer present.

In some examples, when the static code checking system 124 re-executes the automated static code check, it does not do so for the exact batch of development artifacts of the initial run of the automated static code check. Instead, the static code checking system 124 automatically considers any updates that may have been provided in the interim period and adjusts the batch of development artifacts to be targeted by the automated static code check accordingly. For example, in the period between operation 406 and operation 412, or between a developer uploading an initial batch of code and the static code checking system 124 starting the initial run, further updates may have been received at the static code checking system 124, such as new code or changes to previously submitted code. Thus, in some examples, the static code checking system 124 automatically adjusts the batch of development artifacts to account for one or more updates that occurred, and specifically instructs re-execution of the automated static code check for the adjusted batch of development artifacts instead of the original batch. This can improve the efficiency of the static code checking system 124 and allow users to obtain relevant results more rapidly.

At operation 418, the static code checking system 124 then detects successful completion of the automated static code check (e.g., after one or multiple restarts of the automated static code check), and also detects that the automated static code check did not flag any issues from a substantive perspective. In some examples, and as shown in FIG. 4, in response to detecting the successful completion of the automated static code check without any flags being reported, the result handling component 216 of the static code checking system 124 adjusts the status of the relevant development artifacts (e.g., the full batch as checked) at operation 420 to enable or allow integration thereof into the production environment (e.g., integration into the main code base).

In some examples, integration of new or modified code into the production environment is initially disabled, and the static code checking system 124, or another system, such as one of the production integration systems 130 of FIG. 1, only enables such integration once the automated static code check has been successfully completed and there are no issues to be addressed (or the issues have already been addressed). The method 400 concludes at closing loop operation 422.

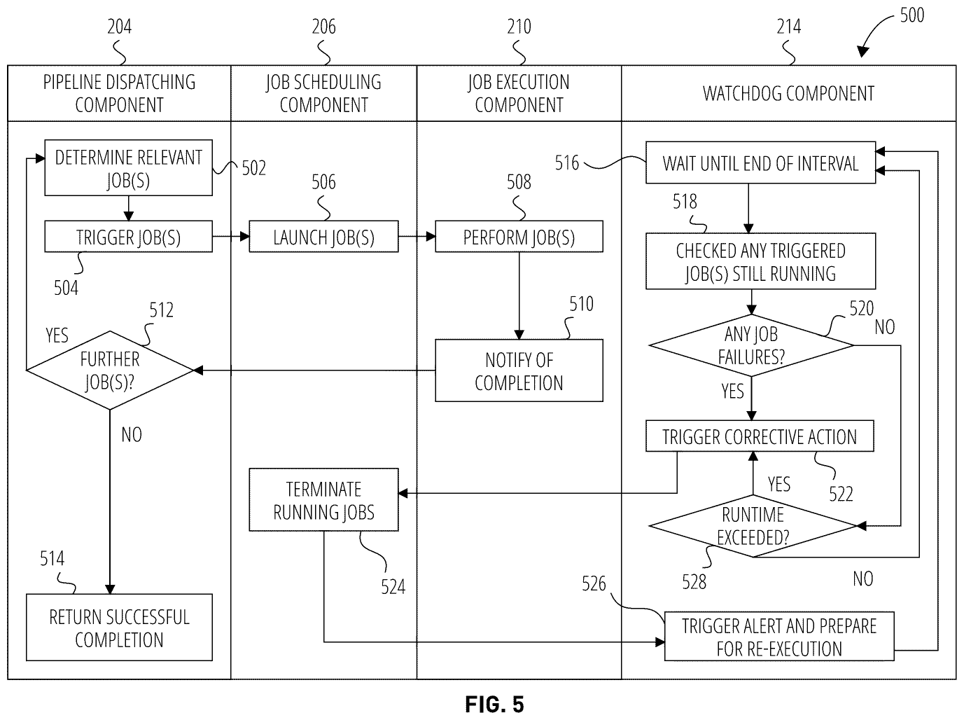

FIG. 5 is a swim-lane flowchart illustrating operations performed by the pipeline dispatching component 204, the job scheduling component 206, the job execution component 210, and the watchdog component 214, respectively, to provide a method 500 for performing an automated and self-healing static code check, according to some examples. It is noted that components of the static code checking system 124 of the FIG. 2 are used as non-limiting examples to describe operations of the method 500.

Referring firstly to operation 502 of FIG. 5, the pipeline dispatching component 204 determines one or more relevant jobs to trigger, based on the job structure metadata for an automated static code check. The one or more jobs are triggered (operation 504) by the pipeline dispatching component 204 and then launched by the job scheduling component 206 (operation 506), after which the job execution component 210 performs the one or more jobs as scheduled by the job scheduling component 206 at operation 508.

The job execution component 210 notifies the pipeline dispatching component 204 after the successful completion of each job, as shown with operation 510 in FIG. 5. In some examples, the job scheduling component 206 or the pipeline dispatching component 204 maintains status data regarding the status of the jobs of the automated static code check in order to schedule upcoming jobs effectively.

The pipeline dispatching component 204 then determines, at decision operation 512, whether any further jobs need to be performed to complete the automated static code check. If so, the method 500 proceeds back to operation 502 and continues as described above. If not, the pipeline dispatching component 204 returns a notification at operation 514 indicating that all jobs have been successfully completed. This can allow, for example, the result handling component 216 shown in FIG. 2 to finalize and cause transmission of the results of the automated static code check (e.g., an indication of which issues, if any, were flagged by the static code checking system 124 based on the various jobs of the automated static code check).

While the job execution component 210 performs the jobs of the automated static code check, the watchdog component 214 automatically runs a watchdog process. As mentioned, the watchdog process can be periodically triggered based on a predetermined interval. For example, and as shown in FIG. 5, the watchdog component 214 waits for the end of the current interval (operation 516) and then checks any jobs that have been triggered by the pipeline dispatching component 204, and are still running at that time (at operation 518). For example, the watchdog component 214 generates a snapshot that shows which jobs are in progress at a particular point in time. The snapshot may also indicate (or be used to determine) which jobs are finalized and which jobs have not yet started.

At decision operation 520, the watchdog component 214 uses the snapshot information as well as the job structure metadata for the automated static code check to determine whether any of the jobs have failed. In this context, a “failure” can be defined in various ways. For example, if a particular job has stalled and the snapshot information indicates that it has been running for longer than a predetermined runtime threshold indicated in the job structure metadata, the watchdog component 214 can designate that job as a failed job. In other cases, the failure may be an outright failure of the computing process that is executed to run the one or more checks or other operations associated with the job.

If the watchdog component 214 determines, at decision operation 512, that there has been a job failure within the automated static code check, the watchdog component 214 triggers corrective action (operation 522). In the method 500 of FIG. 5, the corrective action is triggered by instructing the job scheduling component 206 to cause termination of jobs that are still running (operation 524). The job scheduling component 206 can also be instructed not to schedule any remaining jobs for the current run of the automated static code check.

Additionally, the watchdog component 214 triggers re-execution (e.g., a restart) of the automated static code check. In the case of FIG. 5, the watchdog component 214 triggers a full re-execution of all the jobs of the automated static code check. However, in other examples, the watchdog component 214 may trigger partial re-executions.

Furthermore, in the method 500 of FIG. 5, the watchdog component 214 triggers the transmission of an alert notification to a user device associated with an administrator of the automated static code check and prepares for re-execution of the automated static code check, as shown at operation 526. Once the automated static code check starts again, the watchdog component 214 will periodically generate snapshots according to the interval of operation 516.

If the watchdog component 214 determines, at decision operation 512, that there has not been a job failure within the automated static code check, the method 500 proceeds to decision operation 528, where the watchdog component 214 checks whether the automated static code check as a whole has exceeded a predetermined runtime threshold. In some examples, the predetermined runtime threshold is associated with an expected time that it would take to complete a “healthy” run of the automated static code check (a buffer may be added thereto).

For example, a particular snapshot indicates that one or more jobs are still running and also indicates a current duration of the automated static code check. The watchdog component 214 compares the current duration with the predetermined runtime threshold and detects that the predetermined runtime threshold has been exceeded. In response to this detection, the watchdog component 214 triggers the corrective action (operation 522) as discussed above.

On the other hand, if the watchdog component 214 determines that there has not been a job failure and that the predetermined runtime threshold has not been exceeded, the method 500 proceeds from decision operation 528 back to operation 516. Thus, the watchdog component 214 waits to perform the next check based on the interval.

Accordingly, in some examples, and as shown in FIG. 5, a watchdog process involves an automated assessment that is performed according to a predetermined order. The predetermined order provides that a first assessment to check for any job failures within the automated static code check is performed before a second assessment to check for exceeding of the (overall) predetermined runtime threshold. Furthermore, the watchdog component 214 is configured such that the second assessment is only performed if it detects, as part of the first assessment, that no job failures were identified.

In some examples, termination of the automated static code check resets the static code checking system 124 such that it has a “clean” status with respect to the particular automated static code check. In other words, the static code checking system 124 is cleared for the next execution of the same automated static code check. Given that, in many cases, reasons for failure or stalling of a static code check are non-repeating (e.g., due to intermittent technical issues), the clearing of the static code checking system 124 and automatic re-execution of the automated static code check can be an effective technique. Once the method 500 reaches operation 514, operation of the watchdog component 214 is terminated by the static code checking system 124.

However, the static code checking system 124 can be further configured to respond to multiple re-executions failing to lead to successful execution. For example, the static code checking system 124 is configured to detect that the automated static code check has been re-executed using the operations described above a predetermined number of times without achieving successful completion. In response to this detection, the static code checking system 124 may automatically pause further execution of the automated static code check. For example, the static code checking system 124 may automatically pause or stop the automated static code check with no restarting thereof being triggered. In some examples, the static code checking system 124 transmits a failure message to a user device associated with an administrator in response to detecting that the predetermined number of re-executions has been performed without achieving successful completion, thereby enabling the administrator to investigate the issue.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one memory that stores instructions; and one or more processors configured by the instructions to perform operations comprising: accessing job structure metadata for an automated static code check, the job structure metadata defining a plurality of jobs of the automated static code check, the plurality of jobs being scheduled according to the job structure metadata such that execution of at least a first subset of the plurality of jobs is dependent on successful completion of at least a second subset of the plurality of jobs; commencing execution of the automated static code check; while the automated static code check is in progress: automatically generating a plurality of snapshots of the automated static code check, each of the plurality of snapshots indicating which of the plurality of jobs have been triggered and are still running at a respective point in time; and detecting, based on the job structure metadata and a particular snapshot of the plurality of snapshots, an event comprising at least one of a job failure within the automated static code check or the automated static code check exceeding a predetermined runtime threshold; and in response to detecting the event, automatically terminating and triggering re-execution of one or more of the plurality of jobs of the automated static code check.

In Example 2, the subject matter of Example 1 includes, wherein automatically terminating the one or more of the plurality of jobs of the automated static code check comprises terminating the automated static code check in its entirety, and triggering the re-execution of the one or more of the plurality of jobs of the automated static code check comprises triggering the re-execution of the automated static code check in its entirety.

In Example 3, the subject matter of Example 2 includes, wherein the automated static code check is performed for a batch of development artifacts, and wherein the re-execution of the automated static code check comprises: adjusting the batch of development artifacts to account for one or more updates that occurred between the commencing of the execution of the automated static code check and the detecting of the event; and commencing the re-execution of the automated static code check for the adjusted batch of development artifacts.

In Example 4, the subject matter of Examples 1-3 includes, wherein the automated static code check is performed for a batch of development artifacts prior to integration of the batch of development artifacts into a production environment, and integration of the batch of development artifacts into the production environment is disabled while the automated static code check is in progress, the operations further comprising: detecting that the automated static code check was successfully completed and that the automated static code check did not flag any issues; and in response to detecting that the automated static code check was successfully completed and that the automated static code check did not flag any issues, adjusting a status of the batch of development artifacts to enable the integration of the batch of development artifacts into the production environment.

In Example 5, the subject matter of Examples 1-4 includes, wherein the job structure metadata defines the predetermined runtime threshold, and the particular snapshot indicates that the automated static code check has exceeded the predetermined runtime threshold.

In Example 6, the subject matter of Examples 1-5 includes, wherein the detecting of the event comprises: generating, based on the job structure metadata, an expected state of the automated static code check; and comparing the expected state of the automated static code check with the particular snapshot.

In Example 7, the subject matter of Examples 1-6 includes, wherein the job failure comprises stalling of a particular job of the plurality of jobs.

In Example 8, the subject matter of Example 7 includes, wherein the predetermined runtime threshold is an overall runtime threshold for the automated static code check, the job structure metadata defines the overall runtime threshold and an individual runtime threshold for the particular job, and the job failure is detected based on the individual runtime threshold being exceeded for the particular job.

In Example 9, the subject matter of Examples 1-8 includes, the operations further comprising performing, by a watchdog process and for each of the plurality of snapshots, an automated assessment according to a predetermined order comprising: a first assessment by the watchdog process to check for any job failures within the automated static code check; and a second assessment by the watchdog process to check for exceeding of the predetermined runtime threshold, the second assessment being performed only in response to a detection, by the watchdog process, that no job failures were identified in the first assessment.

In Example 10, the subject matter of Examples 1-9 includes, wherein a watchdog process is periodically executed to generate the plurality of snapshots while the automated static code check is in progress, the watchdog process being executed according to a predetermined interval of between one minute and twenty minutes.

In Example 11, the subject matter of Examples 1-10 includes, the operations further comprising: detecting that the automated static code check has been re-executed a predetermined number of times without successful completion; and in response to detecting that the automated static code check has been re-executed the predetermined number of times without successful completion, automatically performing at least one of: pausing further execution of the automated static code check; or transmitting a failure message to a user device associated with an administrator.

In Example 12, the subject matter of Examples 1-11 includes, wherein the automated static code check is performed for a batch of development artifacts, the operations further comprising: detecting that the automated static code check was successfully completed; and in response to detecting that the automated static code check was successfully completed, automatically transmitting a completion message to at least one user device associated with the batch of development artifacts.

In Example 13, the subject matter of Examples 1-12 includes, the operations further comprising: in response to detecting the event, automatically transmitting a failure message to a user device associated with an administrator.

In Example 14, the subject matter of Examples 1-13 includes, wherein the automated static code check is performed for a batch of development artifacts, the batch of development artifacts comprises a plurality of development artifacts within a checking pipeline, and the operations further comprising: aggregating, based on a predetermined set of rules, the batch of development artifacts into the checking pipeline to cause the batch of development artifacts to undergo the automated static code check.

Example 15 is a method comprising: accessing, by at least one processor, job structure metadata for an automated static code check, the job structure metadata defining a plurality of jobs of the automated static code check, the plurality of jobs being scheduled according to the job structure metadata such that execution of at least a first subset of the plurality of jobs is dependent on successful completion of at least a second subset of the plurality of jobs; commencing, by the at least one processor, execution of the automated static code check; while the automated static code check is in progress: automatically generating, by the at least one processor, a plurality of snapshots of the automated static code check, each of the plurality of snapshots indicating which of the plurality of jobs have been triggered and are still running at a respective point in time; and detecting, by the at least one processor, based on the job structure metadata and a particular snapshot of the plurality of snapshots, an event comprising at least one of a job failure within the automated static code check or the automated static code check exceeding a predetermined runtime threshold; and in response to detecting the event, automatically terminating and triggering re-execution, by the at least one processor, of one or more of the plurality of jobs of the automated static code check.

In Example 16, the subject matter of Example 15 includes, wherein automatically terminating the one or more of the plurality of jobs of the automated static code check comprises terminating the automated static code check in its entirety, and triggering the re-execution of the one or more of the plurality of jobs of the automated static code check comprises triggering the re-execution of the automated static code check in its entirety.

In Example 17, the subject matter of Example 16 includes, wherein the automated static code check is performed for a batch of development artifacts, and the re-execution of the automated static code check comprises: adjusting the batch of development artifacts to account for one or more updates that occurred between the commencing of the execution of the automated static code check and the detecting of the event; and commencing the re-execution of the automated static code check for the adjusted batch of development artifacts.

Example 18 is one or more non-transitory computer-readable media storing computer-executable instructions that, when executed by a computing system, cause the computing system to perform operations comprising: accessing job structure metadata for an automated static code check, the job structure metadata defining a plurality of jobs of the automated static code check, the plurality of jobs being scheduled according to the job structure metadata such that execution of at least a first subset of the plurality of jobs is dependent on successful completion of at least a second subset of the plurality of jobs; commencing execution of the automated static code check; while the automated static code check is in progress: automatically generating a plurality of snapshots of the automated static code check, each of the plurality of snapshots indicating which of the plurality of jobs have been triggered and are still running at a respective point in time; and detecting, based on the job structure metadata and a particular snapshot of the plurality of snapshots, an event comprising at least one of a job failure within the automated static code check or the automated static code check exceeding a predetermined runtime threshold; and in response to detecting the event, automatically terminating and triggering re-execution of one or more of the plurality of jobs of the automated static code check.

In Example 19, the subject matter of Example 18 includes, wherein automatically terminating the one or more of the plurality of jobs of the automated static code check comprises terminating the automated static code check in its entirety, and triggering the re-execution of the one or more of the plurality of jobs of the automated static code check comprises triggering the re-execution of the automated static code check in its entirety.

In Example 20, the subject matter of Example 19 includes, wherein the automated static code check is performed for a batch of development artifacts, and the re-execution of the automated static code check comprises: adjusting the batch of development artifacts to account for one or more updates that occurred between the commencing of the execution of the automated static code check and the detecting of the event; and commencing the re-execution of the automated static code check for the adjusted batch of development artifacts.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

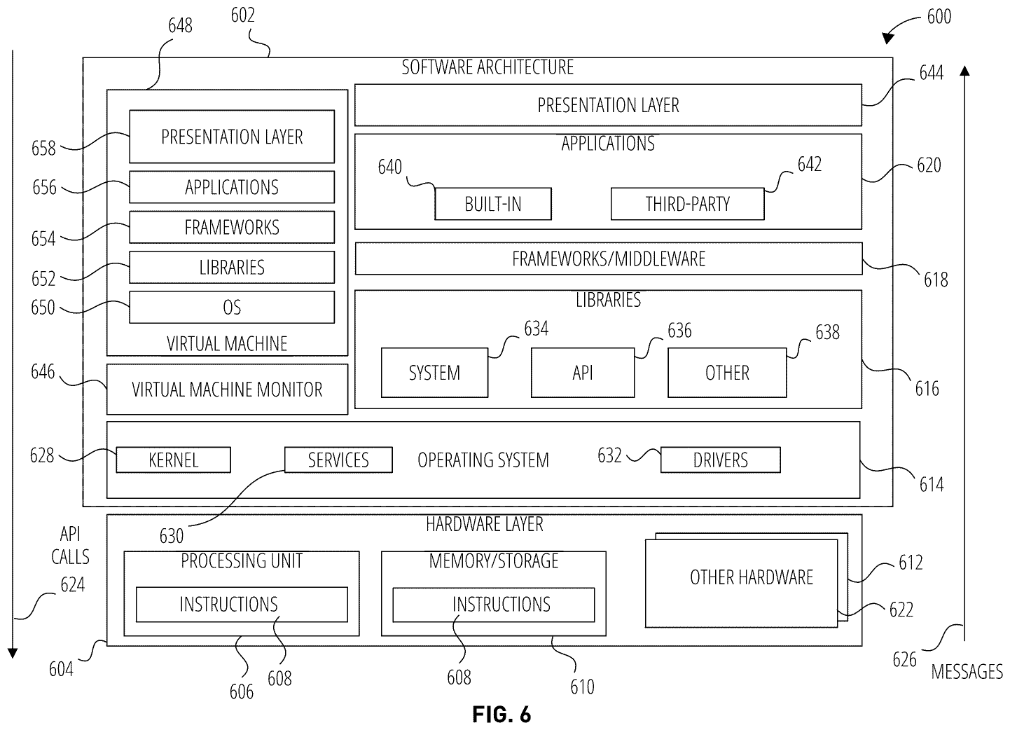

FIG. 6 is a block diagram 600 showing a software architecture 602 for a computing device, according to some examples. The software architecture 602 may be used in conjunction with various hardware architectures, for example, as described herein. FIG. 6 is merely a non-limiting illustration of a software architecture, and many other architectures may be implemented to facilitate the functionality described herein. A representative hardware layer 604 is illustrated and can represent, for example, any of the above referenced computing devices. In some examples, the hardware layer 604 may be implemented according to the architecture of the computer system of FIG. 7.

The representative hardware layer 604 comprises one or more processing units 606 having associated executable instructions 608. Executable instructions 608 represent the executable instructions of the software architecture 602, including implementation of the methods, modules, subsystems, and components, and so forth described herein and may also include memory and/or storage modules 610, which also have executable instructions 608. Hardware layer 604 may also comprise other hardware as indicated by other hardware 612 and other hardware 622 which represent any other hardware of the hardware layer 604, such as the other hardware illustrated as part of the software architecture 602.

In the architecture of FIG. 6, the software architecture 602 may be conceptualized as a stack of layers where each layer provides particular functionality. For example, the software architecture 602 may include layers such as an operating system 614, libraries 616, frameworks/middleware layer 618, applications 620, and presentation layer 644. Operationally, the applications 620 or other components within the layers may invoke API calls 624 through the software stack and access a response, returned values, and so forth illustrated as messages 626 in response to the API calls 624. The layers illustrated are representative in nature and not all software architectures have all layers. For example, some mobile or special purpose operating systems may not provide a frameworks/middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. In some examples, the services 630 include an interrupt service. The interrupt service may detect the receipt of an interrupt and, in response, cause the software architecture 602 to pause its current processing and execute an interrupt service routine (ISR) when an interrupt is accessed.

The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 616 may provide a common infrastructure that may be utilized by the applications 620 or other components or layers. The libraries 616 typically provide functionality that allows other software modules to perform tasks in an easier fashion than to interface directly with the underlying operating system 614 functionality (e.g., kernel 628, services 630 or drivers 632). The libraries 616 may include system libraries 634 (e.g., C standard library) that may provide functions such as memory allocation functions, string manipulation functions, mathematical functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks/middleware layer 618 may provide a higher-level common infrastructure that may be utilized by the applications 620 or other software components/modules. For example, the frameworks/middleware layer 618 may provide various GUI functions, high-level resource management, high-level location services, and so forth. The frameworks/middleware layer 618 may provide a broad spectrum of other APIs that may be utilized by the applications 620 or other software components/modules, some of which may be specific to a particular operating system or platform.

The applications 620 include built-in applications 640 or third-party applications 642. Examples of representative built-in applications 640 may include, but are not limited to, a contacts application, a browser application, a book reader application, a location application, a media application, a messaging application, or a game application. Third-party applications 642 may include any of the built-in applications as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 642 may invoke the API calls 624 provided by the mobile operating system such as operating system 614 to facilitate functionality described herein.

The applications 620 may utilize built in operating system functions (e.g., kernel 628, services 630 or drivers 632), libraries (e.g., system libraries 634, API libraries 636, and other libraries 638), and frameworks/middleware layer 618 to create user interfaces to interact with users of the system. Alternatively, or additionally, in some systems, interactions with a user may occur through a presentation layer, such as presentation layer 644. In these systems, the application/module “logic” can be separated from the aspects of the application/module that interact with a user.

Some software architectures utilize virtual machines. In the example of FIG. 6, this is illustrated by virtual machine 648. A virtual machine creates a software environment where applications/modules can execute as if they were executing on a hardware computing device. A virtual machine is hosted by a host operating system (operating system 614) and typically, although not always, has a virtual machine monitor 646, which manages the operation of the virtual machine as well as the interface with the host operating system (e.g., operating system 614). A software architecture executes within the virtual machine 648 such as an operating system 650, libraries 652, frameworks/middleware 654, applications 656 or presentation layer 658. These layers of software architecture executing within the virtual machine 648 can be the same as corresponding layers previously described or may be different.

Certain examples are described herein as including logic or a number of components, modules, or mechanisms. Modules or components may constitute either software modules/components (e.g., code embodied (1) on a non-transitory machine-readable medium or (2) in a transmission signal) or hardware-implemented modules/components. A hardware-implemented module/component is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module/component that operates to perform certain operations as described herein.

In various examples, a hardware-implemented module/component may be implemented mechanically or electronically. For example, a hardware-implemented module/component may comprise dedicated circuitry or logic that is permanently configured (e.g., as a special-purpose processor, such as a field programmable gate array (FPGA) or an application-specific integrated circuit (ASIC)) to perform certain operations. A hardware-implemented module/component may also comprise programmable logic or circuitry (e.g., as encompassed within a general-purpose processor or another programmable processor) that is temporarily configured by software to perform certain operations.

Accordingly, the term “hardware-implemented module” or “hardware-implemented component” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules/components are temporarily configured (e.g., programmed), each of the hardware-implemented modules/components need not be configured or instantiated at any one instance in time. For example, where the hardware-implemented modules/components comprise, a general-purpose processor configured using software, the general-purpose processor may be configured as respective different hardware-implemented modules/components at different times. Software may accordingly configure a processor, for example, to constitute a particular hardware-implemented module/component at one instance of time and to constitute a different hardware-implemented module/component at a different instance of time.

Hardware-implemented modules/components can provide information to, and receive information from, other hardware-implemented modules/components. Accordingly, the described hardware-implemented modules/components may be regarded as being communicatively coupled. Where multiple of such hardware-implemented modules/components exist contemporaneously, communications may be achieved through signal transmission (e.g., over appropriate circuits and buses that connect the hardware-implemented modules/components). In examples in which multiple hardware-implemented modules/components are configured or instantiated at different times, communications between such hardware-implemented modules/components may be achieved, for example, through the storage and retrieval of information in memory structures to which the multiple hardware-implemented modules/components have access. For example, one hardware-implemented module/component may perform an operation, and store the output of that operation in a memory device to which it is communicatively coupled. A further hardware-implemented module/component may then, at a later time, access the memory device to retrieve and process the stored output.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules/components that operate to perform one or more operations or functions. The modules/components referred to herein may, in some examples, comprise processor-implemented modules/components.

Similarly, the methods described herein may be at least partially processor-implemented. For example, at least some of the operations of a method may be performed by one or more processors or processor-implemented modules/components. The performance of certain of the operations may be distributed among the one or more processors, not only residing within a single machine, but deployed across a number of machines.

The one or more processors may also operate to support performance of the relevant operations in a “cloud computing” environment or as a “software as a service (SaaS).” For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

FIG. 7 is a block diagram of a machine in the example form of a computer system 700 within which instructions 724 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a GPU, or both), a primary or main memory 704, and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a UI navigation (or cursor control) device 714 (e.g., a mouse), a storage unit 716, a signal generation device 718 (e.g., a speaker), and a network interface device 720.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware.

The storage unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 or within the processor 702 during execution thereof by the computer system 700, with the main memory 704 and the processor 702 also each constituting a machine-readable medium 722.

While the machine-readable medium 722 is shown in accordance with some examples to be a single medium, the term “machine-readable medium” may include a single medium or multiple media (e.g., a centralized or distributed database, or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present disclosure, or that is capable of storing, encoding, or carrying data structures utilized by or associated with such instructions 724. The term “machine-readable medium” shall accordingly be taken to include, but not be limited to, solid-state memories, and optical and magnetic media. Specific examples of a machine-readable medium 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 724 may further be transmitted or received over a communications network 726 using a transmission medium. The instructions 724 may be transmitted using the network interface device 720 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 724 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to. ” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. Except as otherwise indicated, the word “or” in reference to a list of two or more items, covers all of the following interpretations of the word: any one of the items in the list, all of the items in the list, and any combination of the items in the list.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

What is claimed is:

1. A system comprising:
at least one memory that stores instructions; and
one or more processors configured by the instructions to perform operations comprising:
accessing job structure metadata for an automated static code check, the job structure metadata defining a plurality of jobs of the automated static code check, the plurality of jobs being scheduled according to the job structure metadata such that execution of at least a first subset of the plurality of jobs is dependent on successful completion of at least a second subset of the plurality of jobs;
commencing execution of the automated static code check;
while the automated static code check is in progress:
automatically generating a plurality of snapshots of the automated static code check, each of the plurality of snapshots indicating which of the plurality of jobs have been triggered and are still running at a respective point in time; and
detecting, based on the job structure metadata and a particular snapshot of the plurality of snapshots, an event comprising at least one of a job failure within the automated static code check or the automated static code check exceeding a predetermined runtime threshold; and
in response to detecting the event, automatically terminating and triggering re-execution of one or more of the plurality of jobs of the automated static code check.

2. The system of claim 1, wherein automatically terminating the one or more of the plurality of jobs of the automated static code check comprises terminating the automated static code check in its entirety, and triggering the re-execution of the one or more of the plurality of jobs of the automated static code check comprises triggering the re-execution of the automated static code check in its entirety.

3. The system of claim 2, wherein the automated static code check is performed for a batch of development artifacts, and wherein the re-execution of the automated static code check comprises:
adjusting the batch of development artifacts to account for one or more updates that occurred between the commencing of the execution of the automated static code check and the detecting of the event; and
commencing the re-execution of the automated static code check for the adjusted batch of development artifacts.

4. The system of claim 1, wherein the automated static code check is performed for a batch of development artifacts prior to integration of the batch of development artifacts into a production environment, and integration of the batch of development artifacts into the production environment is disabled while the automated static code check is in progress, the operations further comprising:
detecting that the automated static code check was successfully completed and that the automated static code check did not flag any issues; and
in response to detecting that the automated static code check was successfully completed and that the automated static code check did not flag any issues, adjusting a status of the batch of development artifacts to enable the integration of the batch of development artifacts into the production environment.

5. The system of claim 1, wherein the job structure metadata defines the predetermined runtime threshold, and the particular snapshot indicates that the automated static code check has exceeded the predetermined runtime threshold.

6. The system of claim 1, wherein the detecting of the event comprises:
generating, based on the job structure metadata, an expected state of the automated static code check; and
comparing the expected state of the automated static code check with the particular snapshot.

7. The system of claim 1, wherein the job failure comprises stalling of a particular job of the plurality of jobs.

8. The system of claim 7, wherein the predetermined runtime threshold is an overall runtime threshold for the automated static code check, the job structure metadata defines the overall runtime threshold and an individual runtime threshold for the particular job, and the job failure is detected based on the individual runtime threshold being exceeded for the particular job.

9. The system of claim 1, the operations further comprising performing, by a watchdog process and for each of the plurality of snapshots, an automated assessment according to a predetermined order comprising:
a first assessment by the watchdog process to check for any job failures within the automated static code check; and
a second assessment by the watchdog process to check for exceeding of the predetermined runtime threshold, the second assessment being performed only in response to a detection, by the watchdog process, that no job failures were identified in the first assessment.

10. The system of claim 1, wherein a watchdog process is periodically executed to generate the plurality of snapshots while the automated static code check is in progress, the watchdog process being executed according to a predetermined interval of between one minute and twenty minutes.

11. The system of claim 1, the operations further comprising:
detecting that the automated static code check has been re-executed a predetermined number of times without successful completion; and
in response to detecting that the automated static code check has been re-executed the predetermined number of times without successful completion, automatically performing at least one of:
pausing further execution of the automated static code check; or
transmitting a failure message to a user device associated with an administrator.

12. The system of claim 1, wherein the automated static code check is performed for a batch of development artifacts, the operations further comprising:
detecting that the automated static code check was successfully completed; and
in response to detecting that the automated static code check was successfully completed, automatically transmitting a completion message to at least one user device associated with the batch of development artifacts.

13. The system of claim 1, the operations further comprising:
in response to detecting the event, automatically transmitting a failure message to a user device associated with an administrator.

14. The system of claim 1, wherein the automated static code check is performed for a batch of development artifacts, the batch of development artifacts comprises a plurality of development artifacts within a checking pipeline, and the operations further comprising:
aggregating, based on a predetermined set of rules, the batch of development artifacts into the checking pipeline to cause the batch of development artifacts to undergo the automated static code check.

15. A method comprising:
accessing, by at least one processor, job structure metadata for an automated static code check, the job structure metadata defining a plurality of jobs of the automated static code check, the plurality of jobs being scheduled according to the job structure metadata such that execution of at least a first subset of the plurality of jobs is dependent on successful completion of at least a second subset of the plurality of jobs;
commencing, by the at least one processor, execution of the automated static code check;
while the automated static code check is in progress:
automatically generating, by the at least one processor, a plurality of snapshots of the automated static code check, each of the plurality of snapshots indicating which of the plurality of jobs have been triggered and are still running at a respective point in time; and
detecting, by the at least one processor, based on the job structure metadata and a particular snapshot of the plurality of snapshots, an event comprising at least one of a job failure within the automated static code check or the automated static code check exceeding a predetermined runtime threshold; and
in response to detecting the event, automatically terminating and triggering re-execution, by the at least one processor, of one or more of the plurality of jobs of the automated static code check.

16. The method of claim 15, wherein automatically terminating the one or more of the plurality of jobs of the automated static code check comprises terminating the automated static code check in its entirety, and triggering the re-execution of the one or more of the plurality of jobs of the automated static code check comprises triggering the re-execution of the automated static code check in its entirety.

17. The method of claim 16, wherein the automated static code check is performed for a batch of development artifacts, and the re-execution of the automated static code check comprises:
adjusting the batch of development artifacts to account for one or more updates that occurred between the commencing of the execution of the automated static code check and the detecting of the event; and
commencing the re-execution of the automated static code check for the adjusted batch of development artifacts.

18. One or more non-transitory computer-readable media storing computer-executable instructions that, when executed by a computing system, cause the computing system to perform operations comprising:
accessing job structure metadata for an automated static code check, the job structure metadata defining a plurality of jobs of the automated static code check, the plurality of jobs being scheduled according to the job structure metadata such that execution of at least a first subset of the plurality of jobs is dependent on successful completion of at least a second subset of the plurality of jobs;
commencing execution of the automated static code check;
while the automated static code check is in progress:
automatically generating a plurality of snapshots of the automated static code check, each of the plurality of snapshots indicating which of the plurality of jobs have been triggered and are still running at a respective point in time; and
detecting, based on the job structure metadata and a particular snapshot of the plurality of snapshots, an event comprising at least one of a job failure within the automated static code check or the automated static code check exceeding a predetermined runtime threshold; and
in response to detecting the event, automatically terminating and triggering re-execution of one or more of the plurality of jobs of the automated static code check.

19. The one or more non-transitory computer-readable media of claim 18, wherein automatically terminating the one or more of the plurality of jobs of the automated static code check comprises terminating the automated static code check in its entirety, and triggering the re-execution of the one or more of the plurality of jobs of the automated static code check comprises triggering the re-execution of the automated static code check in its entirety.

20. The one or more non-transitory computer-readable media of claim 19, wherein the automated static code check is performed for a batch of development artifacts, and the re-execution of the automated static code check comprises:
adjusting the batch of development artifacts to account for one or more updates that occurred between the commencing of the execution of the automated static code check and the detecting of the event; and
commencing the re-execution of the automated static code check for the adjusted batch of development artifacts.
